(19) United States
(12) Patent Application Publication
(10) Pub. No.: US 2006/0050884 A1
(43) Pub. Date: Mar. 9, 2006

(54) Hardened automatic synchronisation scheme for ATM cells

(76) Inventor: Robin E. O'Brien, Ringwood (GB)

Correspondence Address: NIXON & VANDERHYE, PC, 901 NORTH GLEBE ROAD, 11TH FLOOR, ARLINGTON, VA, 22203, US

(21) Appl. No.: 10/052,108

(22) Filed: Jan. 17, 2002

(30) Foreign Application Priority Data
Jan. 23, 2001 (GB) 0101700.3

(51) Int. Cl. H04K 1/00

(52) U.S. Cl. 380/255; 380/287

(57) ABSTRACT

A method of preserving and/or reacquiring synchronisation of ATM cells (10) in an ATM cell transmission system, the ATM cells each including a header (12) and payload (11), the method including the steps of encoding the header and payload and interleaving them along with synchronisation data within a transmission frame.

### FIELD OF THE INVENTION

This invention relates to improvements in Asynchronous Transfer Mode (ATM) data communication systems. More particularly, although not exclusively, this invention relates to techniques and apparatus suitable for preserving synchronisation in ATM data streams.

### BACKGROUND TO THE INVENTION

Asynchronous Transfer Mode (ATM) is a packet oriented system for transferring digital information based on the use of ATM cells. ATM data is transmitted as a contiguous stream of cells where each cell has a constant length and comprises a header label of 5 bytes and a payload field of 48 bytes.

The system is asynchronous in that the cells are identified by means of address information carried in the header label and not by their position in relation to a fixed time reference.

Frame synchronisation is the process by which incoming frame delineation signals are identified. Delineation sequences correspond to distinctive bit sequences which can be distinguished from data bits. The synchronisation process allows the data bits within the frame to be extracted for decoding or retransmission. It is known in the prior art to insert, in a dedicated time slot within the frame, a noninformation bit that is used for the actual synchronisation of the incoming data with the receiver. In the present application, data (or frame) synchronization is used to detect and delineate the boundaries of the code word from which the (ATM) cells are extracted.

The address field is divided into two parts, the virtual path identifier (VPI) and the virtual channel identifier (VCI). The header label also includes, amongst other things, an 8-bit CRC field for header error control.

The relatively small and constant size of an ATM cell allows ATM hardware to transmit video, audio and data over the same network with cell prioritisation being handled by appropriate fields in the header.

A significant problem in many data transmission networks, including ATM systems, is data loss/corruption which can cause loss of data synchronisation.

Data or frame synchronisation is necessary for asynchronous data transmission as the data packets can arrive at irregular intervals. Therefore, the switches or other processing hardware must have a way of delineating the incoming cells or frames. Loss of synchronisation may possibly not damage the cells content per se. However, loss of synchronisation will cause packet loss leading to excessive retransmit requests thus reducing the bandwidth utilisation and the speed of the link.

The present invention is primarily concerned with techniques for preserving cell synchronisation and restoring synchronisation acquisition after synchronisation loss. In a broader sense, the present invention relates to techniques by which resistance to cell corruption (in particular synchronisation errors) can be enhanced. This general technique is referred to as “cell hardening” in the present application.

The following discussion will be given in the context of tactical networks, specifically those found in military environments. However, this is not to be construed as a limiting application. The present invention may be applied in any environment where loss and restoration of synchronisation is a problem.

High error rates, leading to loss of synchronisation may be the result of the intrinsic nature of the battlefield environment, natural causes or manmade interference such as jamming. This latter source of error may be particularly problematic in the case of man-made jamming which targets frame boundaries in order to corrupt the data stream in a systematic way.

An object of the present invention is therefore to provide a method and apparatus which enhances the resistance of (or “hardens”) an ATM data stream to loss of synchronisation.

### DISCLOSURE OF THE INVENTION

In one aspect, the invention provides for a method of preserving and/or reacquiring synchronisation of ATM cells in an ATM cell transmission system, the ATM cells each including a header and payload, the method including the steps of encoding the header and payload and interleaving them along with synchronisation data within a transmission frame.

Error correction may be applied separately to the header and payload prior to framing them in the transmission frame.

The error correction may correspond to Reed Solomon forward error correction.

The Reed Solomon encoding may be applied to the header and payload separately following which the encoded header may be interleaved with the synchronisation data and encoded payload.

The synchronisation data may correspond to a synchronisation word selected to have low auto and cross-correlation characteristics.

The method of the invention may include the further step of eliminating/using empty/idle ATM cells in such a way that input and output data rates of an ATM link over which the processed ATM cells are transmitted, are substantially matched.

In a further aspect, the invention provides for a method of preserving and/or reacquiring synchronisation of ATM cells in an ATM cell transmission system, the method comprising the steps of:
at a first location, for a plurality of transmission frames each containing an encoded ATM cell, interleaving synchronisation data within said frames, prior to transmission via an ATM transmission link;
transmitting the plurality of processed frames via a transmission link;
receiving, at a second location, the framed ATM cells;
de-interleaving the received frames in order to extract the synchronisation data; and
monitoring the synchronisation data and depending on whether a predetermined number of incorrect/correct synchronisation data elements are detected, establishing synchronisation, triggering resynchronisation or triggering attempted reacquisition of synchronisation.

The synchronisation data may be interleaved throughout the ATM cell in such a way as to render the ATM cell substantially insensitive to interference targeted at cell boundaries.

In a further aspect, the invention provides for an apparatus for manipulating ATM cells in an ATM transmission system adapted to operate in accordance with the method as hereinbefore defined.

### BRIEF DESCRIPTION OF THE DRAWINGS

The invention will now be described by way of example only and with reference to the figures in which:

FIG. 1: illustrates a prior art ATM cell structure;

FIG. 2: illustrates framing and interleaving applied to an ATM cell;

FIG. 3: illustrates a simplified schematic of the architecture of an ATM cell hardening device/unit;

FIG. 4: illustrates a schematic of a simplified portion of an ATM network showing the location of a cell hardening unit/device;

FIG. 5: illustrates a simplified block schematic for a prototype cell hardening device/unit (CHU);

FIG. 6: illustrates a frame synchronisation state machine; and

FIG. 7: illustrates a simplified frame format.

The following discussion will generally relate to ATM transmission of data in error-prone military environments. However, other types of network may be amenable to operation with the present invention.

The synchronisation preservation system and method described herein is, in one embodiment, intended for protecting ATM trunks being carried over, for example, a radio relay link that is subject to a tactical environment. Other applications are envisaged, such as protecting satellite links.

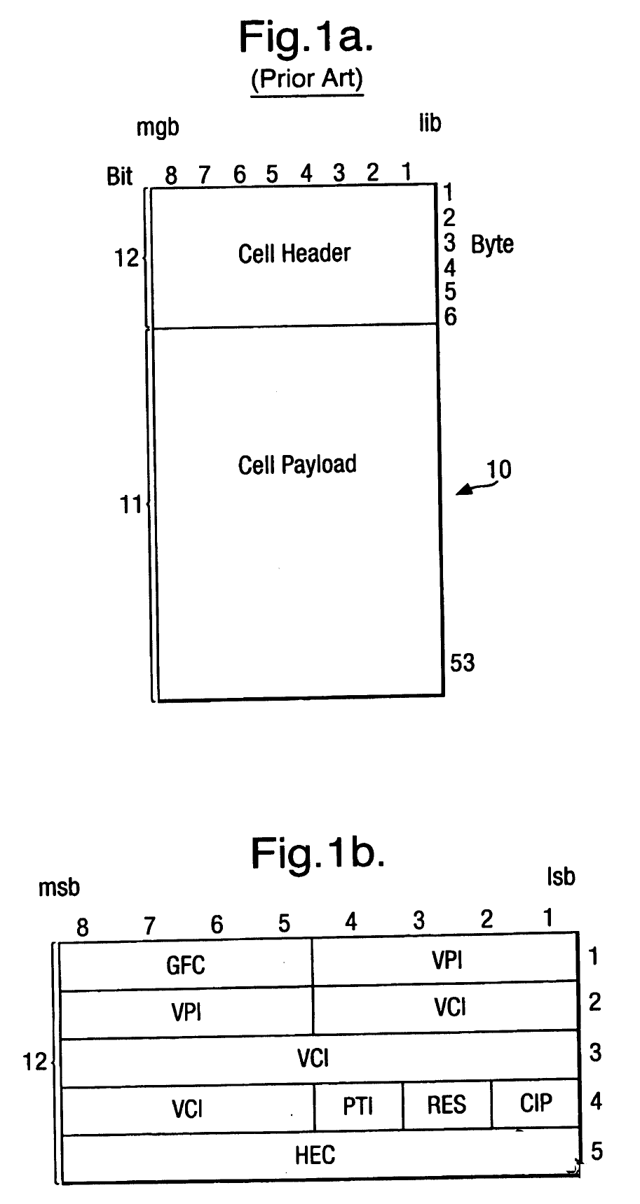

FIG. 1 illustrates a schematic of a prior art ATM packet. ATM packet 10 (hereafter referred to as a cell) consists of a payload field 11 and header 12. The payload 11 is 48 bytes and may correspond to network user information such as data, voice, images etc. The payload 11 can also carry overhead or operations and maintenance information. The header 12 (shown in detail in FIG. 1b) includes: an address field (including a VPI: virtual path identifier and VCI: virtual channel identifier) which defines the virtual channel to which the cell is assigned; payload type identifier PTI; an 8-bit CRC field for header error control (HEC), this field also provides a mechanism for cell structure delineation.

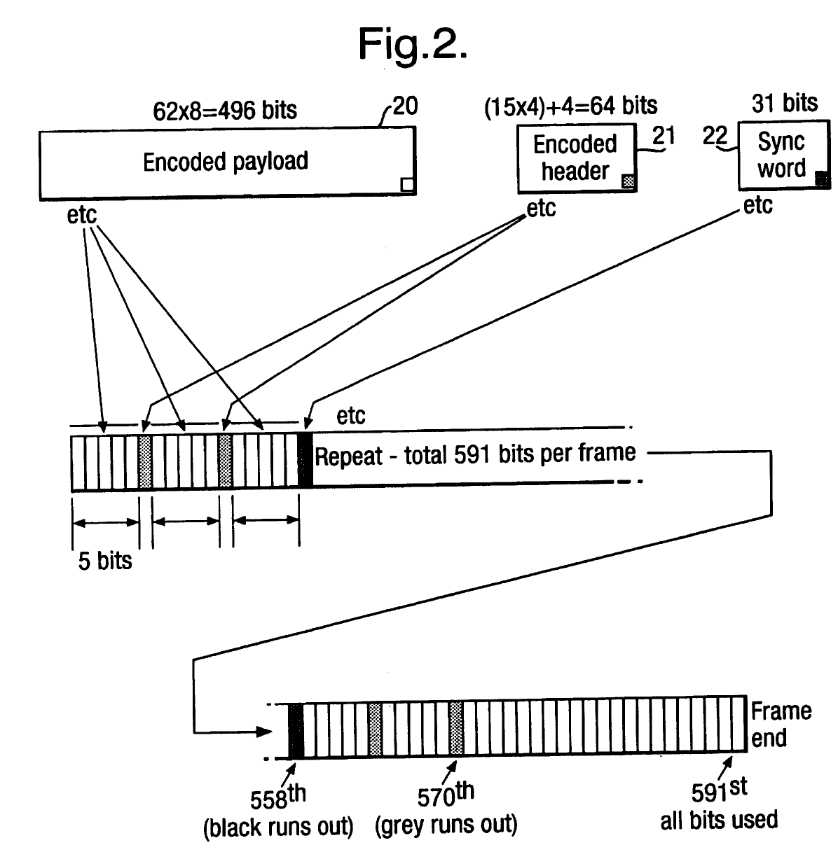

FIG. 2 illustrates a schematic of the cell hardening technique with FIG. 7 showing an encoded and framed cell. For details of the cell hardening technique as it applies to the header and payload data, the reader is referred to the ATM cell hardening technique described in Applicants' copending UK patent application [Invention Docket No. XA1294/1295].

As discussed in the abovementioned copending application, the individual ATM cells are encapsulated within an error correction codeword. Therefore if the error correction is overloaded, only a single cell is compromised and error multiplication is avoided. Within an ATM cell, the header bytes are particularly sensitive in that if they are corrupted, this will cause total loss of the cell. Using knowledge of the header position in conjunction with header encoding, an additional level of protection is provided for. In addition, the header check byte may be replaced by stronger code to achieve additional protection and to identify uncorrectable headers.

As is discussed in more detail in Applicants' copending UK patent application [Invention Docket No. XA1296] additional bits are used in the hardened ATM cell. These extra bits are used to provide extra encoding for the payload and header. They may be derived from idle of unassigned ATM cells, if available, otherwise they contribute to link overheads.

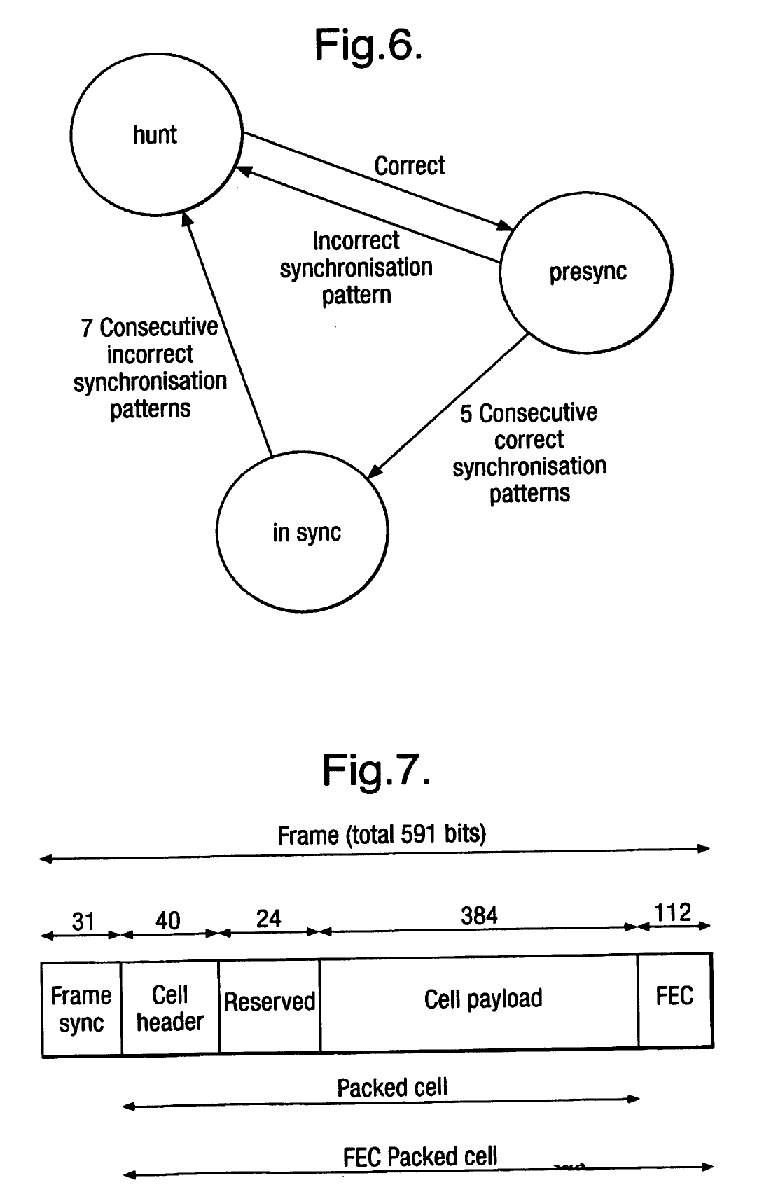

ATM cells encoded in this manner are, according to the present invention, accompanied by a synchronisation pattern. Synchronisation in this context relates to cell or frame, not bit, synchronisation. Standard ATM employs a cell synchronisation method based on delineating cell boundaries from information in the header. This method is suitable for low error rate links. However, error prone links such as radio frequency a satellite data streams need a more rugged form of synchronisation. To this end, the encoded ATM cell contains a synchronisation word which is detected at the ATM switch or cell hardening device/unit (hereafter referred to as a CHU) to provide initial cell acquisition and to restore cell acquisition after synchronisation loss. This information is also used at the receiving CHU (see below) to delineate the boundaries of codewords from which cells are subsequently extracted. Cell delineation according to known ATM techniques functions by looking for the header (over a 5 byte period) by calculating the check byte on each byte in the window and declaring a match with the header and header error check byte being matched. This is partially shown in FIG. 6 which illustrates a state machine for the synchronisation process.

In accordance with the invention, the synchronisation word is interleaved within a transmission frame that contains an encoded ATM cell. This makes the cell more resistant to an attack by a jamming pulse. The reason for this is that there are no regions of the cell that are particularly vulnerable to attack by an interfering pulse. The synchronisation data is delocalised and therefore no particular portion is susceptible to jamming errors. This is particularly relevant to jamming techniques which look for frame boundaries in order to corrupt the data stream in a systematic way.

The synchronisation word is conventional and is selected to have low auto and cross-correlation (for a selected environment). For synchronisation establishment/re-establishment, an algorithm is applied on top of the data stream to analyse the synchronisation word.

Returning to the structure of the hardened ATM cell, FIGS. 2 and 7 shows an encoded payload 20, encoded header 21 and the 31-bit synchronisation word 32 interleaved into a contiguous bit stream forming a frame 591 bits in length. Each cell therefore contains two complete Reed Solomon codewords which maximises protection against errors for the shorter, non-payload elements. The hardened ATM cells are then transmitted via the network.

Reed Solomon forward error correction is used as the basic element of the design architecture. This type of encoding was chosen as it provides a good mix of bit error and burst error correction and is relatively straightforward to implement.

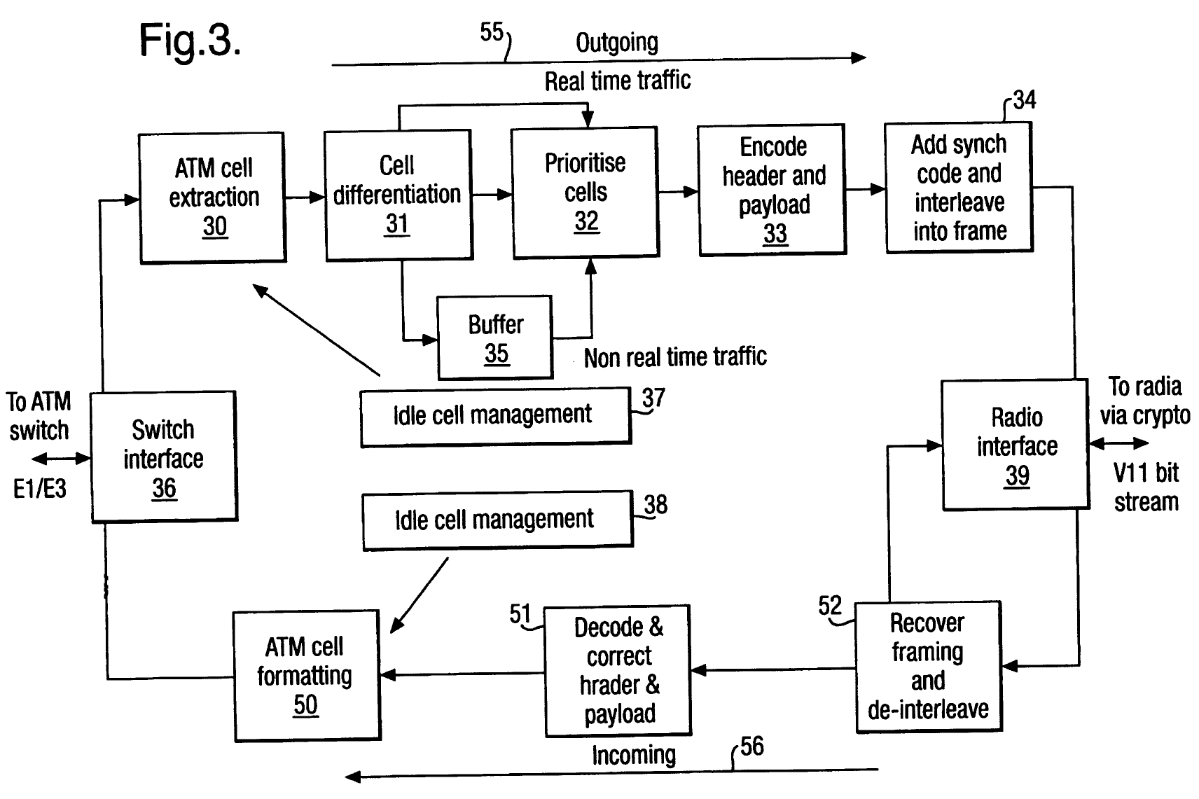

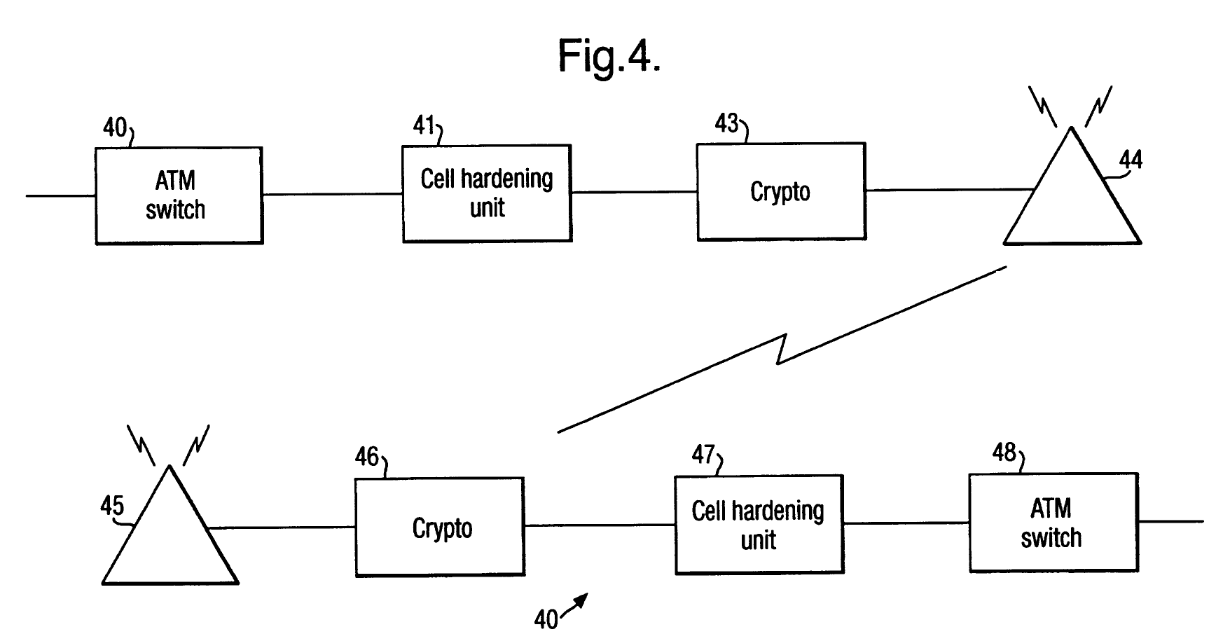

Referring to FIGS. 3 and 4, incoming frames containing encoded cells from, for example, a radio link, are subjected to a synchronisation recovery mechanism. This establishes the frame boundaries so that decoding and encoding correction can be performed.

On reception of the hardened ATM cell over, for example, a radio link, the decoded and corrected cell header and payload elements are reformed into a valid ATM cell which is passed to the ATM switch. If the Reed Solomon decoding of the header fails, the cell is discarded. If required, idle cells are sent to the ATM switch in order to maintain the physical link rate of the connection.

FIG. 4 shows the general layout of a simplified portion of an ATM network illustrating the location of the cell hardening devices. A standard ATM switch 40 receives ATM cells from a network (not shown). These are passed to a Cell Hardening Unit (CHU) 41. The hardened cells may be subject to cryptographic processes and are then transmitted via, for example, an RF link 44/45. The hardened cells are received by receiver 45, decrypted (if necessary) and decoded by the CHU 47. The unpacked cells are then passed to an ATM switch for transmission via the network.

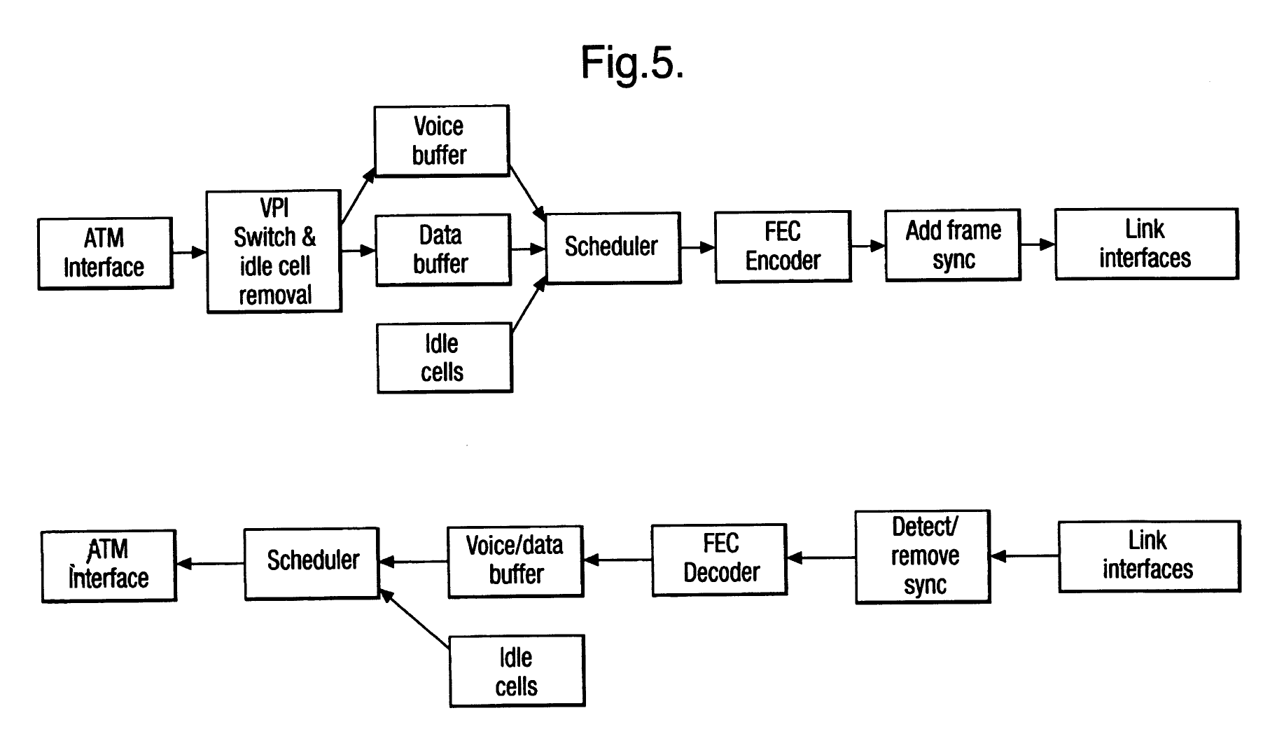

The operation of a preferred embodiment of the CHU is as follows. FIG. 3 illustrates a schematic of an illustrative CHU architecture. The outgoing path (55) shown in FIG. 3 accepts traffic cells from an ATM switch (not shown). The VPI value of the cell header is then checked (32) to identify the cell as one of the two supported types. For example, if the VPI is odd, then the cell contains voice information and will be given a high priority. If the VPI is even, the cell contains data and will follow a lower priority route through the CHU. The cell is then stored in the data or voice buffer (35) as appropriate. If the buffers are full, then the cell is discarded. Cells are removed from the buffer when the transmitter is able to take them. Cells in the data buffer are only processed when the voice buffer is empty. Similarly, when both buffers are empty, idle cells are generated and transmitted. Data cells are not transmitted when the radio interface receiver is out of sync. However voice and idle cells continue to be transmitted when the radio interface is reporting out of sync. According to the operation of a prototype CHU, the cell is then converted into a packed cell by inserting 3 dummy bytes between the cell head and the cell payload. This embodiment of the CHU is shown in FIG. 5. However, in the preferred form of the invention, and that discussed in detail herein, the three dummy bytes correspond to reserved areas for implementing, amongst other things, header protection etc.

The 56 byte packed cell is then passed to the Reed Solomon encoder (33) for forward error correction encoding. After a processing delay, the FEC packed cell is read from the Reed Solomon encoder and serially clocked out of the encoder at a selectable rate.

A 31-bit synchronisation word is then added to the end of each FEC packed cell and the data is interleaved to form a frame (34). The series of frames (hardened ATM cells) then leaves the device as a contiguous bit stream which is then sent for transmission on, for example, a radio link (39).

The incoming path (56) shown in FIG. 3 accepts a bit stream, delineated by interleaved synchronisation words, of hardened ATM cells from a radio link and resynchronises (52) to the frames contained within the bit stream. When a number of patterns are found that are in close agreement with the expected synchronisation pattern and are each one frame apart, the receiver is deemed to be in synchronisation. As the frame payload is cell delineated (52) idle and unassigned cells (37) are discarded. If synchronisation fails, the CHU sends idle cells to the ATM switch.

In terms of the synchronisation word, preferably a 31-bit Maximal Length Sequence (MLS) code is used to identify the frame boundaries. MSL codes are considered to have desirable autocorrelation properties. Positive and negative correlation may be detected. Positive correlation occurs when a large number of bits are in agreement between the MLS code and the input pattern, for example, 28 or more out of 31. A negative correlation occurs when the number of bits that agree with the input is less than a certain threshold, for example, when 3 or less out of 31 bits agree. The negative correlation is, in a preferred embodiment, equal to 31 minus the positive threshold.

The delineated cells are converted back into forward error corrected packed cells and are passed to the Reed Solomon decoder (51). If the output of the Reed Solomon decoded bitstream contains less than one complete cell, an idle cell is inserted (38). This ensures that a continuous stream of cells is emitted from the CHU interface. The reconstructed ATM cells (50) are then passed to the ATM switch (36).

Further details of the incoming and outgoing traffic flow which, read in conjunction with FIG. 3 and the description above, shows further details of the cell handling procedure.

In the present implementation of the invention, the positive threshold may be adjusted using a manual control on the CHU hardware. Frame synchronisation is considered to be achieved when 6 consecutive synchronisation patterns have been received, each with a correlation result not less than the positive threshold value or not more than the negative threshold value. Frame synchronisation is considered to be lost when 7 consecutive incorrect frame synchronisation patterns are received. The number of correct/incorrect frames required by the synchronisation algorithm may be adjusted by an alteration at the software level.

Referring to FIG. 6, the present embodiment of the synchronisation preservation method and apparatus checks for the presence of the synchronisation pattern on a bit by bit basis. When in the presynchronisation state, at least one correct synchronisation pattern has been detected and the CHU will then count one frame length to the next frame pattern and then check the pattern belonging to the next frame. Hence when in the presynchronisation or synchronisation states, the CHU counts from one frame to the next and checks the synchronisation pattern. When synchronisation is lost, the CHU returns to checking the input pattern on a bit by bit basis.

In trials, the radio link has been resynchronised without intervention within 25 ms at 2048 kbps and 100 ms at 512 kbps in an error environment of 10⁻² random BER or better.

Thus by the invention described herein and the embodiments referred to above, the present invention provides for an ATM cell handling and transmission technique and apparatus which have been demonstrated to reliably maintain traffic within a desired error range.

Although the present invention has been described by way of example only and with reference to the possible embodiments thereof, it to be appreciated that improvements and/or modifications may be made thereto without departing from the scope of the invention as set out in the appended claims.

Where in the foregoing description reference has been made to integers or components having known equivalents, then such equivalents are herein incorporated as if individually set forth.

1-11. (canceled)

12. A method of preserving synchronization of ATM cells in an ATM cell transmission system, the ATM cells each including a header and payload, the method including the steps of encoding the header and payload and interleaving the encoded header and payload with synchronization data within a transmission frame.

13. A method of preserving and reacquiring synchronization of ATM cells in an ATM cell transmission system, the ATM cells each including a header and payload, the method including the steps of encoding the header and payload and interleaving the encoded header and payload with synchronization data within a transmission frame.

14. A method of reacquiring synchronization of ATM cells in an ATM cell transmission system, the ATM cells each including a header and payload, the method including the steps of encoding the header and payload and interleaving the encoded header and payload with synchronization data within a transmission frame.

15. A method as claimed in any of claims 12, 13 or 14 wherein error correction is applied separately to the header and payload prior to framing them in the transmission frame.

16. A method as claimed in claim 15 wherein the error corrections corresponds to Reed Solomon forward error correction.

17. A method as claimed in claim 16 wherein the Reed Solomon encoding is applied to the header and payload separately following which the encoded header is interleaved with the synchronization data and encoded payload.

18. A method as claimed in any of claims 12, 13 or 14 wherein the synchronization data corresponds to a synchronization word selected to have low auto and cross-correlation characteristics.

19. A method as claimed in any of claims 12, 13 or 14 including the further step of eliminating empty ATM cells in such a way that input and output data rates of an ATM link over which the processed ATM cells are transmitted, are substantially matched.

20. A method as claimed in any of claims 12, 13 or 14 wherein there are at least some idle ATM cells and including the further step of using idle ATM cells in such a way that input and output data rates of an ATM link over which the processed ATM cells are transmitted, are substantially matched.

21. A method of preserving synchronization of ATM cells in an ATM cell transmission system, comprising the steps of:
at a first location, for a plurality of transmission frames each containing an encoded ATM cell, interleaving synchronization data within said frames, prior to transmission via an ATM transmission link;
transmitting the plurality of processed frames via a transmission link;
receiving, at a second location, the framed ATM cells;
de-interleaving the received frames in order to extract the synchronization data; and
monitoring the synchronization data and depending on whether a predetermined number of incorrect/correct synchronization data elements are detected, establishing synchronization, triggering resynchronization or triggering attempted reacquisition of synchronization.

22. A method of preserving and reacquiring synchronization of ATM cells in an ATM cell transmission system, comprising the steps of:
at a first location, for a plurality of transmission frames each containing an encoded ATM cell, interleaving synchronization data within said frames, prior to transmission via an ATM transmission link;
transmitting the plurality of processed frames via transmission link;
receiving, at a second location, the framed ATM cells;
de-interleaving the received frames in order to extract the synchronization data; and
monitoring the synchronization data and depending on whether a predetermined number of incorrect/correct synchronization data elements are detected, establishing synchronization, triggering resynchronization or triggering attempted reacquisition of synchronization.

23. A method of reacquiring synchronization of ATM cells in an ATM cell transmission system, comprising the steps of:
at a first location, for a plurality of transmission frames each containing an encoded ATM cell, interleaving synchronization data within said frames, prior to transmission via an ATM transmission link;
transmitting the plurality of processed frames via a transmission link;
receiving, at a second location, the framed ATM cells;
de-interleaving the received frames in order to extract the synchronization data; and
monitoring the synchronization data and depending on whether a predetermined number of incorrect/correct synchronization data elements are detected, establishing synchronization, triggering resynchronization or triggering attempted reacquisition of synchronization.

24. A method as claimed in any of claims 12, 13, 14, 20, 21 or 22 wherein the synchronization data is interleaved throughout the ATM cell in such a way as to render the ATM cell substantially insensitive to interference targeted at cell boundaries.

25. An apparatus for manipulating ATM cells in an ATM transmission system adapted to operate in accordance with the method of any of claims 12, 13, 14, 20, 21 or 22.
